(19) United States
(12) Patent Application Publication
(10) Pub. No.: US 2006/0118683 A1
(43) Pub. Date: Jun. 8, 2006

(54) Strip merchandisers

(76) Inventors: Neil Hugh Forsyth Speed, Nottingham (GB); Alec Michael Simpson, Nottingham (GB)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 10/523,575

(22) PCT Filed: Jul. 30, 2003
(86) PCT No.: PCT/GB03/03302

§ 371 Date: Aug. 17, 2005

(30) Foreign Application Priority Data
Jul. 31, 2002 (GB) 0217652.7

(51) Int. Cl. F21V 21/00

(52) U.S. Cl. 248/222.11

(57) ABSTRACT

A strip merchandiser (40) for use with an automated loading mechanism as an elongate body portion (42) having a plurality of longitudinally spaced product mounting hooks (44) capable of being raised and lowered as the strip passes through the mechanism and a header portion (46) on the body portion (42), said header portion (46) having different characteristics to those of the body portion so that it cannot readily pass through the mechanism wherein the strip merchandiser (40) at or adjacent the intersection between the header portion (46) and the body portion (42) is provided with means (50) to allow the header portion to pass above the mechanism. Said means (50) here is a neck portion created by lateral cuts (52, 54).

### FIELD OF THE INVENTION

This invention relates to strip merchandisers. Strip merchandisers, also known as clip-strips, generally comprise an elongate strip having means thereon to carry multiples of product which can be suspended on or from a shelf or other retail display device.

### BACKGROUND OF THE INVENTION

Strip merchandisers are becoming more widely used throughout the retail trade to take advantage of cross-selling opportunities between products and to create impulse purchases without using valuable shelf space.

Strip merchandisers such as these are widely known and are described in numerous US patents including U.S. Pat. No. 4,483,502 & U.S. Pat. No. 4,546,943.

Increasingly the supplier is being required by the larger retailers, store chains, supermarkets and the like to supply products pre-loaded on strip merchandisers or clip-strips. Strip merchandisers have been designed which can be readily pre-loaded prior to delivery to retailers by incorporating as the means to carry the product a plurality of longitudinally spaced cuts in the elongate sheet material. The usual form of cut is a ‘w’ shape where the centre of the ‘w’ forms a hook on which product may be hung. Products can thus be attached to each hook so that on arrival in the store the fully loaded strip can be simply removed from its outer packaging with say a dozen packs of product already hanging from it.

This laden strip can then be placed immediately into its display position without any additional labour or merchandising effort by the employees of the store. This generates additional sales at a lower labour or intervention cost. The merchandising labour cost is effectively passed back, up the supply chain to the vendor who is able to undertake the task in a theoretically more controlled, more productive, lower cost factory environment than a shop floor.

It will be seen that there is still an increase in overall costs and that it is the manufacturer who has the additional labour cost in further processing product in this way. To this end a number of mechanisms and apparatus have been designed to automate the loading process. Two of these are described in U.S. Pat. Nos. 5,647,118 and 6,195,877. Both of these are somewhat complex and provide for the loading of a continuous length of strip merchandiser material supplied from a roll. Additionally such mechanisms are costly and have several disadvantages especially where precut lengths of strip are used.

Therefore, a simpler mechanism has been developed which involves a cog being turned by an electric motor, which cog opens the clips on the strip merchandiser one at a time, to enable the product to be loaded onto the clip. This is achieved by the fingers on the cog pushing up against the central portion of the ‘w’ shaped hook each side of which is held down by a metal holding plate. The rotating cog then pulls the strip through between two metal plates to open the next clip position for loading. Due to the memory of the material used the ‘w’ shaped hook snaps closed upon release thereby holding the product onto the strip merchandiser during distribution and display.

Due to the varying demands of retailers it is sometimes required that the strip merchandiser be manufactured with a label holder section so that a standard shelf edge label can be displayed with the product displayed. This is to provide the normal point of sale information, such a name, price and the like unambiguously next to the products displayed on a particular strip merchandiser. Such a label holder may be provided by a series of opposed ‘v’ shaped cuts in a header portion of the strip merchandiser between which a label can be inserted. In addition an adhesive mounting portion may be incorporated into the design so that the strip merchandiser can be simply attached and suspended from any surface in the store suitable for the display of the product loaded thereon. An alternative to this would be the provision of a hole or notch in the header portion for attachment to a hook or other suspension means on a shelf or other display apparatus.

It is also the case that the market often requires a larger label holder section in order to effectively present marketing messages or printed branding. Consequently, the header portion is of a larger, usually wider, dimension to that of the body portion of the strip merchandiser. The result of such strip merchandiser design variables is that the cog is constructed to open and close the central hook segment of the ‘w’ shaped cut and thus due to the pitch or separation of the “fingers” on the wheel that make up the cog the top portion of the strip merchandiser will not fit through the mechanism resulting in that the loading of the strip merchandiser cannot be undertaken semi-automatically using the machine and so creating increased assembly costs for the manufacturer.

It has been noted that one manufacturer has brought to the market a strip having a widened label holder section which incorporates longitudinal fold lines in the line with the edges of the main body portion of strip merchandiser. This has a drawback in that the side wings thus created on each individual strip merchandiser must be manually folded to enable the strip merchandiser to pass through the mechanism. This solution has a number of other disadvantages. Firstly, the wings need to be manually returned to the flat plane of the header and do not always fold back totally flat resulting in a less than satisfactory area on which the manufacturers brand cannot be neatly displayed. In addition this method does not readily incorporate the above mentioned design for holding non-adhesive labels since the ‘v’ cuts would be too weak to withstand weight loading.

Attempts have been made to develop a mechanism to take strip merchandisers with these additional, functional sections whereby the pitch of the cog is increased to such an extent that the length of the strip merchandiser has to be significantly increased to an extent which is unviable based upon the increased material content.

### SUMMARY OF THE INVENTION

According to a first aspect of the present invention a strip merchandiser for use with an automated loading mechanism of the type described comprises an elongate body portion having a plurality of longitudinally spaced product mounting hooks capable of being raised and lowered as the strip passes through the mechanism and a header portion on the body portion, said header portion having different characteristics to those of the body portion so that it cannot readily pass through the mechanism characterized in that the strip merchandiser at or adjacent the intersection between the header portion and the body portion is provided with means to allow the header portion to pass above the mechanism.

It will be seen that the present invention has the result of enabling such strip merchandisers which have a header portion having a greater width than the body portion and/or an adhesive section and/or means to attach a label to be successfully run through the machine without increasing or amending the pitch of the cog or in creasing the spacing between the clips resulting in a longer, higher material content (more expensive) strip merchandiser. In use it a relatively simple task for the header portion to be raised slightly to allow it to pass through the mechanism. It is also possible to provide on the mechanism mechanical means to lift the header portion in certain circumstances.

In one embodiment the means to allow the header portion to pass above the mechanism is provided by a section of reduced width at or adjacent the intersection between the header portion and the body portion whereby a neck portion is created by simply providing a pair of opposed lateral cuts.

Said cuts may be provided by completely removing the material from either side of the neck portion or alternatively each cut may in the form of an incomplete ‘c’ wherein one leg of the ‘c’ does not continue through to the edge of the strip.

In another embodiment the neck portion, or that section of the strip intermediate the cuts, may be provided with means to encourage bending of the neck. Such means may include the provision of transverse score line or crease or a series of perforations in the material which also encourage bending.

It will be seen by one skilled in the art that the use of transverse score lines and the like does not have a detrimental effect on the appearance and use of the strip merchandiser incorporating the present invention. The weight of a strip, whether loaded or not, is sufficient to straighten out the neck once the strip is hanging upon a display.

It is a further advantage of the present invention that when packing loaded strip in cartons for transport and delivery to retailers oversize header portions can be folded over thereby reducing the packed length of the strips resulting in more efficient use of space.

As can also be seen by one skilled in the art the present invention allows any strip merchandiser with a label holder section of any size or configuration to be modified to pass across the holding plates thus enabling semi-automatic loading of virtually any configuration of strip merchandiser given an understanding of the achievable pitch variables of the cog and its relationship to the hook spacing of the SM. A header panel of any size and shape will now be compatible with the machine without any adjustment being required to a standard loading machine.

According to a second aspect of the present invention a machine for loading product on strip merchandisers having a plurality of longitudinally spaced hook portions and the like comprises a cogwheel rotatable by any convenient means and mounted between a pair of planar guide members whereby a strip merchandiser can be drawn under the guide members by rotation of the cogwheel through engagement with the hook portions, which engagement also acts to open each successive hook for loading characterized in that there is provided means to mechanically lift a header portion (if present) of the strip merchandiser.

The cogwheel may be rotated manually but is preferably rotated by an electric motor controlled by a pedal or other suitable means.

The means to mechanically lift the header portion may be provided by any convenient means such as a ramp or pair of ramps leading up to a point above the level of the plane of the guide members.

It will be seen by one skilled in the art that a strip merchandiser of the type described in accordance with the first aspect of the present invention having a header portion of a wider dimension that the body portion will be drawn through the loader in the usual manner until the edges of the header portion engage the lower end of the ramp or ramps and the header portion is raised up the ramp so that when it reaches the guide members it is held above said members so that the strip merchandiser can proceed through the loader.

### BRIEF DESCRIPTION OF THE DRAWINGS

FIG. 1 is a perspective of a section of strip merchandiser loading machine showing the mechanism for opening the hooks;

FIG. 2 is a plan of the machine of FIG. 1 showing the mechanism in operation;

FIG. 3 is a plan of the upper portion of a strip merchandiser having a label holder in the header portion and a neck portion in accordance with the invention;

FIG. 4 corresponds to FIG. 3 but shows a strip merchandiser having a wide header portion and a ‘c’ cut and neck arrangement in accordance with the invention;

FIG. 5 corresponds to FIG. 4 but shows a score line in the neck portion of the strip merchandiser;

FIG. 6 is an underneath plan of the upper portion of a strip merchandiser having self adhesive strips on the header portion and a ‘c’ cut and neck arrangement together with transverse perforations in the neck portion in accordance with the invention;

FIG. 7 corresponds to FIG. 1 but shows a strip merchandiser loading machine incorporating means to mechanically raise the header portion of a strip merchandiser in accordance with a second aspect of the invention; and

FIG. 8 corresponds to FIG. 7 but shows a strip merchandiser with the header portion duly raised.

### DESCRIPTION OF THE PREFERRED EMBODIMENTS

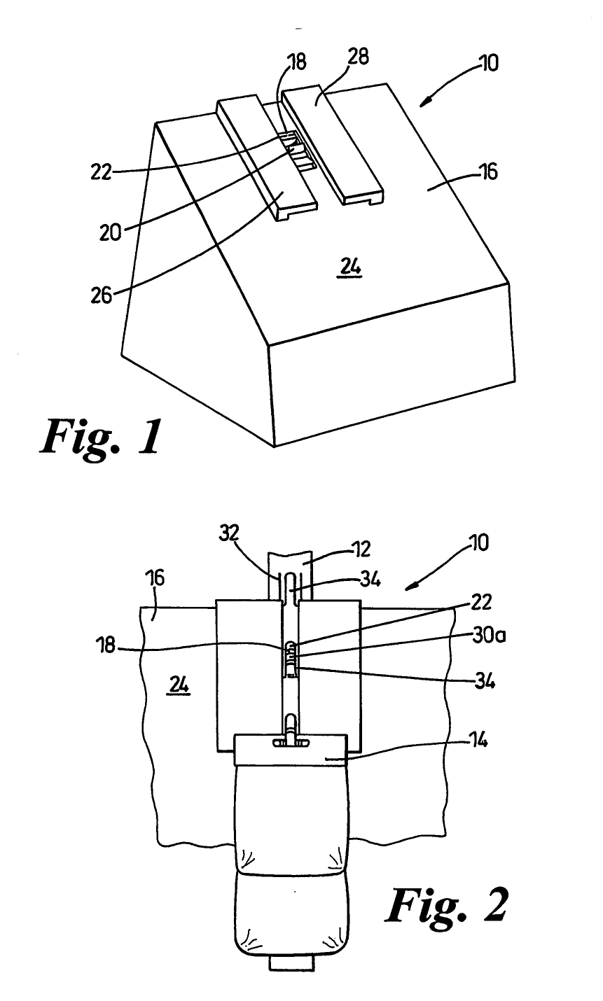

Referring first to FIGS. 1 and 2 of the drawings a machine 10 for loading strip merchandisers 12 (in FIG. 2) with product 14 comprises a casing 16 housing a motor (not shown) for operating a cogwheel 18 having fingers 20 extending through an opening 22 in the top 24 of the casing and a pair of guide plates 26, 28 on each side of the cogwheel 18. As can be seen in FIG. 2 a strip merchandiser 12 is passed under the guide plates 26, 28 and a finger 30a of the cogwheel 18 engages a ‘w’ shaped cut 32 in the strip merchandiser 12 so that the strip merchandiser is drawn through the mechanism and at the same time the central portion of the ‘w’ shaped cut 32 forms a hook 34 and is lifted up and so that product 14 may be attached. Once the ‘w’ shaped cut 32 has moved beyond the cogwheel 18 the hook 34 returns to its original position and the product 14 is held firmly in place. Meanwhile the next finger 30b of the cogwheel 18 engages the next and subsequent ‘w’ shaped cuts 32 until all the hooks carry product.

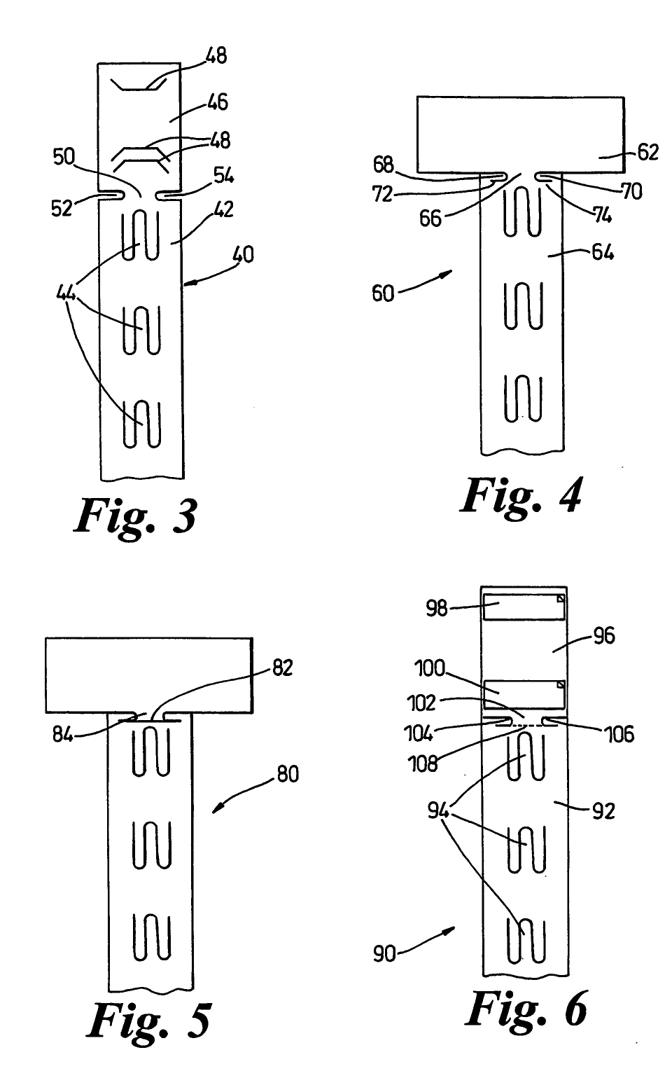

FIG. 3 shows a strip merchandiser 40 in accordance with the invention comprising an elongate body portion 42 having a plurality of longitudinally spaced product mounting hooks 44 and a header portion 46 on the body portion, said header portion having slots or cuts 48 to receive a label (not shown) and at the intersection between the header portion and the body portion there is a neck portion 50 created by lateral cuts 52, 54 provided by completely removing the material from either side of the neck portion.

In FIG. 4 a strip merchandiser 60, generally of the type described above, has a header portion 62 of a width greater than the width of its body portion 64 and a neck portion 66 formed between cuts 68, 70 each in the form of an incomplete ‘c’ wherein one leg 72, 74 of each ‘c’ does not continue through to the edge of the strip.

In FIG. 5 a strip merchandiser 80 similar to the strip merchandiser of FIG. 4 is provided with a transverse score-line 82 across its neck portion 84 to promote bending.

In FIG. 6 a strip merchandiser 90 comprises an elongate body portion 92 having a plurality of longitudinally spaced product mounting hooks 94 and a header portion 96 on the body portion, said header portion having a pair of self adhesive strips 98, 100 to facilitate attachment to a shelf or other display apparatus and a neck portion 102 between ‘c’ shaped cuts 104, 106 of the type described above and a transverse line of perforations 108 is provided across the neck portion 102 to promote bending.

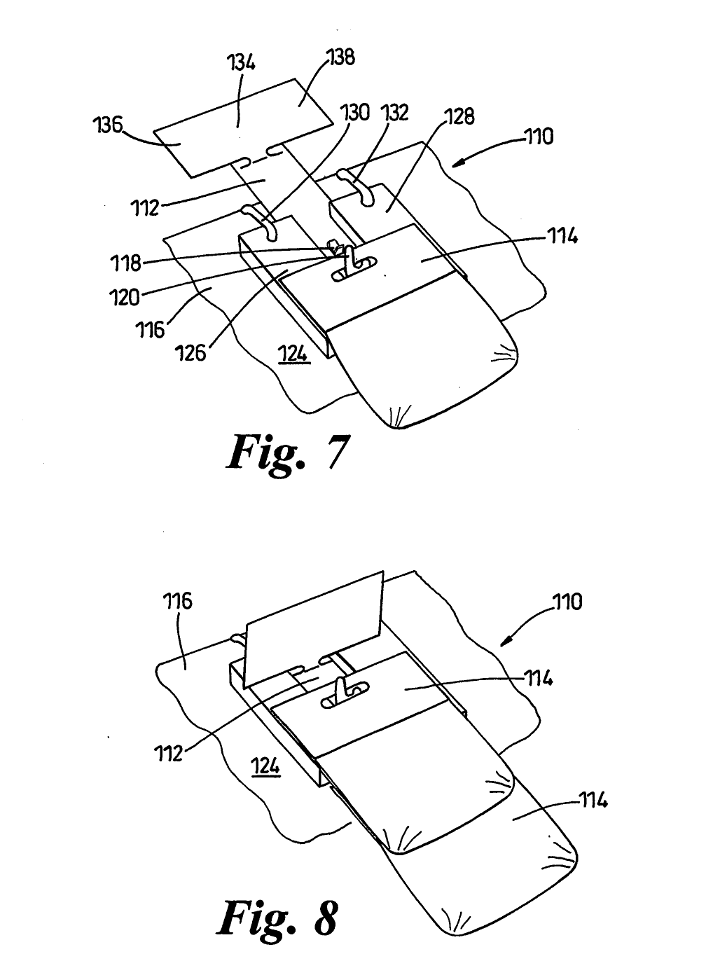

FIGS. 7 and 8 illustrate a machine 110 for loading strip merchandisers 112 with product 114 in accordance with a second aspect of the invention which comprises a casing 116 housing a motor (not shown) for operating a cogwheel 118 having fingers 120 extending through an opening 122 in the top 124 of the casing and a pair of guide plates 126, 128 on each side of the cogwheel 118. The machine 110 is further provided with a pair of ramps 130, 132 leading up to a point above the level of the plane of the guide plates 126, 128.

In FIG. 8 the header portion 134 of the strip merchandiser 112 is raised up as the edges 136, 138 thereof engage respective ramps 130, 132 so that it passes over the guide pates 136, 138 as the strip merchandiser progresses through the mechanism.

1. A strip merchandiser for use with an automated loading mechanism of the type described comprising an elongate body portion having a plurality of longitudinally spaced product mounting hooks capable of being raised and lowered as the strip passes through the mechanism and a header portion on the body portion, the header portion having different characteristics to those of the body portion so that it cannot readily pass through the mechanism characterized in that the strip merchandiser at or adjacent the intersection between the header portion and the body portion is provided with means to allow the header portion to pass above the mechanism.

2. A strip merchandiser as in claim 1 wherein the means to allow the header portion to pass above the mechanism is provided by a section of reduced width at or adjacent the intersection between the header portion and the body portion whereby a neck portion is created by simply providing a pair of opposed lateral cuts.

3. A strip merchandiser as in claim 2 wherein the cuts are provided by completely removing the material from either side of the neck portion.

4. A strip merchandiser as in claim 2 wherein each cut is in the form of an incomplete ‘c’ wherein one leg of the ‘c’ does not continue through to the edge of the strip.

5. A strip merchandiser as in claim 1 wherein the neck portion, or that section of the strip intermediate the cuts, is provided with means to encourage bending of the neck.

6. A strip merchandiser as in claim 5 wherein such means includes the provision of transverse score line or crease or a series of perforations in the material which also encourage bending.

7. A machine for loading product on strip merchandisers having a plurality of longitudinally spaced hook portions and the like comprising a cogwheel rotatable by any convenient means and mounted between a pair of planar guide members whereby a strip merchandiser can be drawn under the guide members by rotation of the cogwheel through engagement with the hook portions, which engagement also acts to open each successive hook for loading characterized in that there is provided means to mechanically lift a header portion (if present) of the strip merchandiser.

8. A machine as in claim 7 wherein the cogwheel is rotated manually.

9. A machine as in claim 7 wherein the cogwheel is rotated by an electric motor controlled by a pedal or other suitable means.

10. A machine as in claim 7 wherein the means to mechanically lift the header portion is provided by any convenient means such as a ramp or pair of ramps leading up to a point above the level of the plane of the guide members.

11-12. (canceled)
